(19) United States
(12) Patent Application Publication
(10) Pub. No.: US 2022/0412505 A1
(43) Pub. Date: Dec. 29, 2022

(54) TV BRACKET

(71) Applicant: NINGBO SOMLE AUDIO-VISUAL TECHNOLOGY CO., LTD, NINGBO (CN)

(72) Inventors: Liming TAO, NINGBO (CN); Weibin JIA, NINGBO (CN)

(21) Appl. No.: 17/356,007

(22) Filed: Jun. 23, 2021

(51) Int. Cl. F16M 11/22; F16M 13/02; F16M 11/20

(52) U.S. Cl. CPC F16M 11/22; F16M 13/02; F16M 11/2014

(57) ABSTRACT

A TV bracket is disclosed in the present invention, including a support frame and a frame for installing a TV. The frame is supported by the support frame. The support frame is rotatably or fixedly connected to the frame, and the frame is of a frame body structure. An end frame opening of the frame is provided with a hanging arm for installing the TV, a space in a frame opening behind the hanging arm forms an accommodating space, and a cable management rack is arranged in the accommodating space. In the present solution, the frame is designed into a frame body structure, the space in the frame opening is the accommodating space to facilitate putting in various accessories of the TV, and the TV is installed with the hanging arm, which is convenient to install. The cable management rack is added to manage cables in an orderly manner, which is convenient to use.

### TECHNICAL FIELD

The present invention relates to the field of TV installation device technologies, and in particular, to a simple TV bracket.

### BACKGROUND

TVs have become indispensable items in people's lives. TVs can spread culture, knowledge, news, messages, and the like, thus enriching people's amateur cultural life, and making people happy and mentally relaxed. With the development of technologies, most current TVs are LCD flat panel TVs, which are generally placed on TV cabinets or coffee tables through bases, or installed on TV brackets, walls, or the like through hanging arms. In terms of a TV bracket, as disclosed in the patent No. U.S. Pat. No. 8,408,505B2, a TV bracket is supported by a column, and an end of the column is connected to a frame through a plurality of parts such as a shaft and a nut to form a pivotal connection structure. The assembly structure is complicated, inconvenient to operate, and high in cost. In addition, the above structure is inconvenient to deploy cables and other wiring components, and is poor in aesthetics, thus requiring improvement.

### SUMMARY OF THE INVENTION

In order to solve at least one of the above technical defects, the present invention provides the following technical solutions:

A TV bracket is disclosed in the first aspect of the present application, including a support frame and a frame for installing a TV, the frame being supported by the support frame, wherein the support frame is rotatably connected to the frame, the frame is of a frame body structure, an end frame opening of the frame is provided with a hanging arm for installing the TV, a space in a frame opening behind the hanging arm forms an accommodating space, and a cable management rack is arranged in the accommodating space.

In the present solution, the frame is designed into the frame body structure, the space in the frame opening is the accommodating space to facilitate putting in various accessories of the TV, and the TV is installed with the hanging arm at the end frame opening of the frame, which is convenient to install. The cable management rack is added to manage cables in an orderly manner, which is convenient to use.

Further, the support frame includes a support column and a tray, the tray is arranged on the support column, a jack is arranged at the bottom of the frame and extends in an axial direction of the support column, an end of the support column protrudes into the jack, and the tray abuts against the bottom of the frame body of the frame to support it.

The bracket uses the end of the support column to directly protrude into the jack at the bottom of the frame, supports the frame with the tray, and installs the TV, such as a liquid crystal screen, with the frame, which simplifies the installation structure, reduces the cost, and facilitates assembly.

The support column and the jack may be fitted tightly or loosely. In terms of tight fit, the frame is relatively stable, and in terms of loose fit, it is convenient for the frame to rotate with respect to the support column to adjust the orientation.

Further, the frame has holes opened at corresponding positions at middle of the bottom and at the top of the frame body to form jacks to simplify the frame structure, reduce the cost and weight, and improve the stability of the frame on the support column.

Further, the tray is arranged over the support column, and abuts against the support column by a first fastener arranged on a peripheral side of the tray to stay at a position of the support column, the tray is fixed on the support column by a fastener, such as a bolt, thus being convenient to adjust the height according to customer needs.

Further, the jack on the frame and the support column are loosely fitted, a protruding component is arranged on a surface of the tray abutting against the bottom of the frame, an arc-shaped groove is arranged correspondingly at a position of the bottom of the frame for the protruding component to protrude in, and the protruding component is limited by the arc-shaped groove to limit a rotational amplitude of the frame.

Further, a second fastener is screwed to the bottom of the tray, and a top of the second fastener protrudes from the surface of the tray abutting against the bottom of the frame to form the protruding component.

Further, the protruding component is integrally formed on the surface of the tray abutting against the bottom of the frame body.

Further, the support frame includes a support column and a tray, the tray is fixed at an end of the support column, a hole is arranged in an axial direction at the end of the support column, an inserting column is arranged at the bottom of the frame, the inserting column is inserted into the hole, and the tray abuts against the bottom of the frame to form a support.

Further, a curtain is arranged at a frame opening on the back of the frame to cover the frame opening, and covering the frame opening with the curtain improves the aesthetics and sealing performance.

Further, the cable manager includes a body, at least one surface of the body is provided with a plurality of bumps at intervals, and the bumps are used as supports for winding cables and the like, which helps the cables to be placed in an orderly manner.

For example, the bumps are T-shaped, longitudinal ends of the bumps are fixed to the body of the cable manager, and the T-shaped bumps are fixed to the body to form a groove-like structure, which facilitates winding of the cables and prevents the cables from detaching.

For example, the body of the cable manager is of a split type, including at least two independent individuals, and each independent individual is provided with several bumps at intervals. The split type structure reduces the weight and cost.

Further, two ends of the hanging arm are bent in the same direction, one end is bent into an L shape, and the other end is bent into a hook body, a top or bottom surface of the frame corresponding to the hook body is provided with a plurality of holes at intervals in a length direction for a hook end of the hook body to protrude in, and the end bent into the L shape is fixed to the bottom or top of the frame by a third fastener. The position of the hanging arm can be fine-tuned in the horizontal direction, which is more flexible.

Further, an elastic rope is arranged on the hanging arm, and the elastic rope is used to bind or tighten the cables.

A novel TV bracket is disclosed in the second aspect of the present application, including a support frame and a frame for installing a TV, the frame being supported by the support frame, wherein the support frame is fixedly connected to the frame, the frame is of a frame body structure, an end frame opening of the frame is provided with a hanging arm for installing the TV, a space in a frame opening behind the hanging arm forms an accommodating space, and a cable management rack is arranged in the accommodating space.

Further, the support frame includes at least one support column, and the support column is fixedly connected to the frame.

Preferably, for example, there are two support columns arranged oppositely on two sides of the bottom of the frame, and a base is installed at the bottom of the support column during use, so that the base can maintain balance and ensure the stability.

Further, a curtain is provided at a frame opening on the back of the frame to cover the frame opening.

Further, the cable manager includes a body, and at least one surface of the body is provided with a plurality of bumps at intervals.

Further, two ends of the hanging arm are bent in the same direction, one end is bent into an L shape, and the other end is bent into a hook body, a top or bottom surface of the frame corresponding to the hook body is provided with a plurality of holes at intervals in a length direction for a hook end of the hook body to protrude in, and the end bent into the L shape is fixed to the bottom or top of the frame by a third fastener.

Further, an elastic rope is arranged on the hanging arm.

Compared with the prior art, the present invention has the following beneficial effects:

1. The present invention simplifies the structure of the TV bracket, facilitates assembly and use, and reduces the cost.

### BRIEF DESCRIPTION OF THE DRAWINGS

In order to illustrate the technical solutions in the embodiments of the present invention more clearly, accompanying drawings used in the description of the embodiments will be introduced briefly below. It is apparent that the accompanying drawings in the following description are only some embodiments of the present invention. For those of ordinary skill in the art, other accompanying drawings can be obtained from these accompanying drawings without creative efforts.

FIG. 1 is a structural diagram of the present TV bracket;

FIG. 2 is an exploded structural diagram of FIG. 1;

FIG. 3 is a structural diagram of fitting of a protruding component on a tray and an arc-shaped groove;

FIG. 4 is a structural diagram of a connection between a hanging arm and a frame;

FIG. 5 is a structural diagram of different frames;

FIG. 6 is a structural diagram of a connection between a frame and a support column;

FIG. 7 is a structural diagram of a cable manager;

FIG. 8 is a structural diagram of a connection of a protruding component on a tray;

FIG. 9 is a structural diagram of a hanging arm;

FIG. 10 is a structural diagram of a connection between a frame and a support column;

FIG. 11 is an overall structural diagram of a fixed connection between a frame and a support column; and

FIG. 12 is a structural diagram of a support column provided with a base.

In the drawings, reference numerals are:
1. Support column; 2. Tray; 3. Frame; 4. Hanging arm; 5. Cable management rack; 6. Curtain; 7. Accommodating space; 8. Elastic rope; 9. Cable hole; 10. Jack; 11. First fastener; 12. Cable; 13. Second fastener; 14. Third fastener; 15. Base; 16. Inserting column; 21. Protruding component; 22. Gasket; 31. Arc-shaped groove; 41. Hook body; 42. Pendant; 50. Body; 51. Split body; 52. Bump; 53. Clamping block.

### DETAILED DESCRIPTION

The present invention will be further illustrated below with reference to the accompanying drawings and specific embodiments.

### Embodiment 1

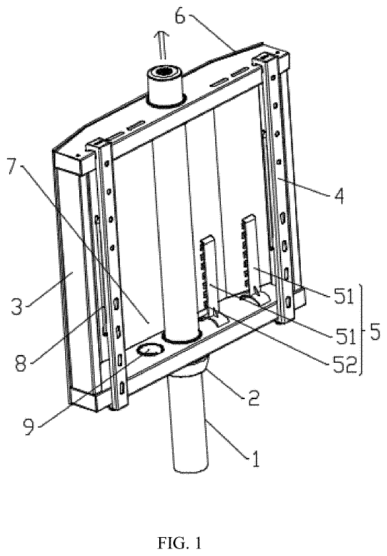

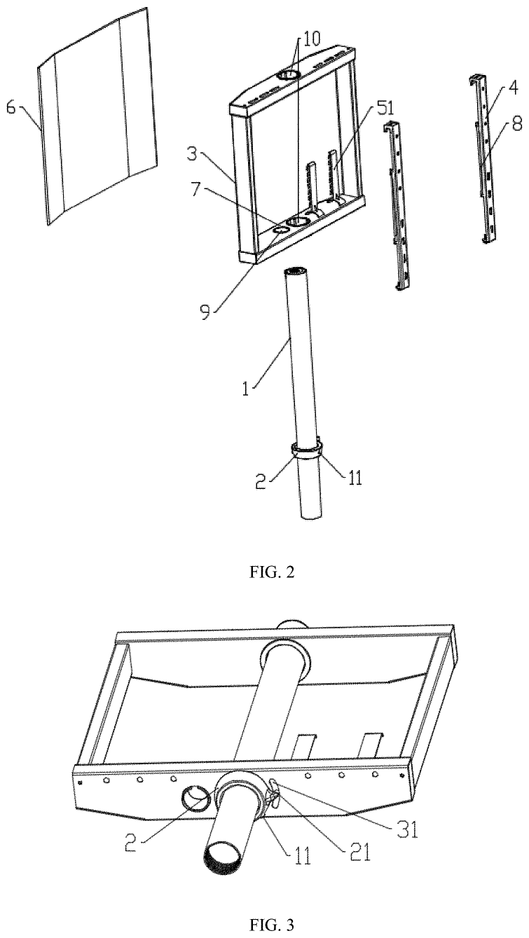

FIG. 1 shows a preferred composition structure of the present TV bracket. As shown in the drawing, a support frame includes a support column and a tray. Tray 2 is installed on support column 1, and frame 3 used to install a TV is of a rectangular frame body structure. In an axial direction of the support column (shown by the arrow in the drawing), holes are opened in corresponding positions at middle of a bottom frame body and a top frame body of the frame to form jacks 10. As shown in FIG. 2, an end of support column 1 is inserted from the jack and penetrates through frame 3. The diameter of the support column is slightly smaller than the hole diameter of the jack to form a loose fit to facilitate rotation. The bottom of the frame abuts against tray 2, and the frame is supported by the tray. Hanging arm 4 is installed on the front of the frame, and a flat panel TV is installed by the hanging arm. Cable hole 9 is reserved at the bottom of the frame body of the frame to facilitate wiring.

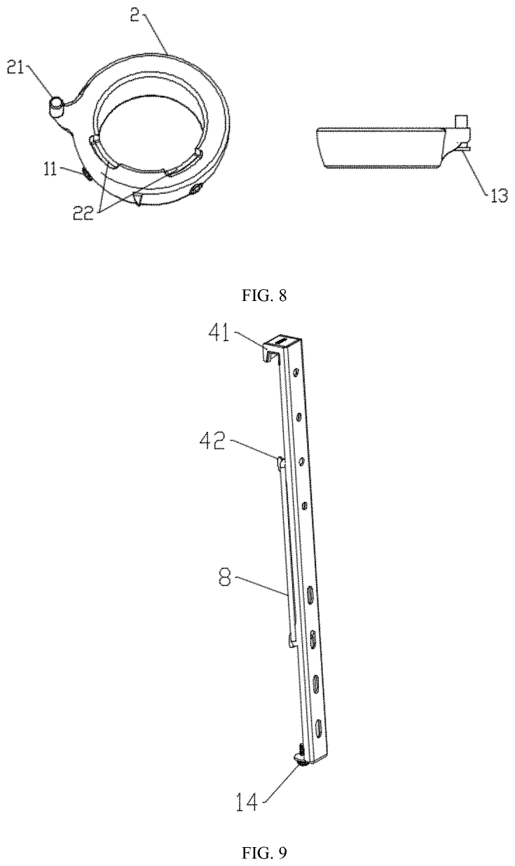

As shown in FIG. 1 and FIG. 2, support column 1 is directly sleeved in a central opening of tray 2. A plurality of threaded holes are pre-formed radially on the peripheral side of the tray. First fastener 11 such as a bolt is screwed into the threaded hole and abuts against support column 1 to fix the tray on the support column. The position of the tray on the support column can be adjusted by loosening first fastener 11. Of course, the tray can be fixed by directly integrally forming or welding it at a certain height of the support column as needed. As shown in the left part of FIG. 8, two threaded holes are radially formed on the tray and first bolt fasteners 11 are screwed therein. In FIG. 8, a notch is opened on an inner hole wall of the tray, and gasket 22 is placed at the notch. The gasket is in rotational fitting with an end of the first fastener, and the first fastener is screwed so that gasket 22 abuts against support column 1, thus increasing a contact area and improving the stability. The top surface of the tray is preferably a plane to better support the frame. In order to limit a rotation amplitude of the frame with respect to the support column, protruding component 21 is installed on the surface of the tray abutting against the bottom of the frame, that is, a rod-shaped or column-shaped component protruding from the top surface of the tray. Arc-shaped groove 31 is reserved in a position at the bottom of the frame corresponding to the protruding component, and an end of protruding component 21 protrudes into arc-shaped groove 31. Referring to FIG. 3, when the frame rotates, the protruding component abuts against the end of the arc-shaped groove to limit the rotation of the frame. A column-shaped protruding component may be directly formed integrally at one side of a top surface of the tray, as shown in the left part of FIG. 8. Alternatively, a threaded hole is reserved, bolt type second fastener 13 is screwed into the bottom of the tray through the threaded hole, and a part of the second fastener protruding from the top surface is used as the protruding component, as shown in the right part of FIG. 8.

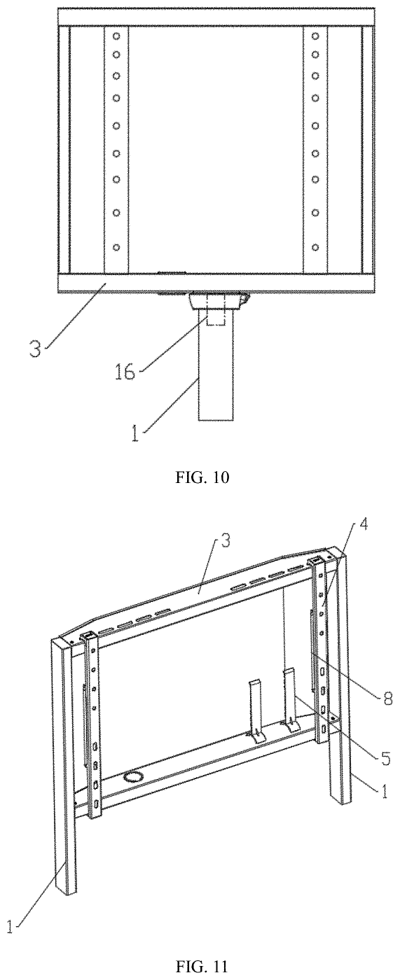

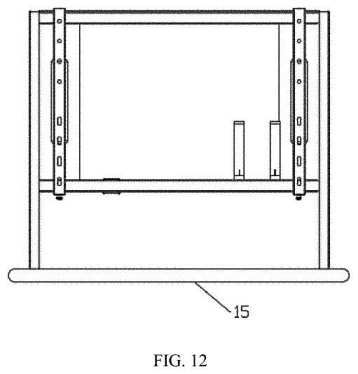

As shown in FIG. 1 and FIG. 2, in the present embodiment, a hanging arm is installed at a front frame opening of frame 3, and the TV is installed through hanging arm 4. Two hanging arms are installed on the frame at an interval, as shown in FIG. 9. Both top and bottom ends of the present hanging arm are bent, wherein the top end is bent to form hook body 41, and the bottom end is L-shaped. A plurality of holes are reserved at intervals at the top of the frame in a length direction for a hook end of a hook body to protrude in. A bottom end opening of the hanging arm is abutted against the bottom of the frame through bolt type third fastener 14 to fix hanging arm 4 on frame 3. A plurality of holes may also be reserved at the bottom of the frame in the length direction for the third fastener to protrude in. The middle part of hanging arm 4 has a plurality of holes spaced apart to facilitate docking with the TV. In addition, without considering adjusting the position of the hanging arm, hanging arm 4 can also be integrally formed directly at the front frame opening of frame 3, as shown in FIG. 4.

As shown in FIG. 1, in the present embodiment, accommodating space 7 is formed in a frame opening of the frame. Preferably, back edges of the bottom and top of a frame body of frame 3 are extended in a width direction, so that the width of the bottom and top is increased, and accommodating space 7 is enlarged, so that TV accessories such as a cable board and a router can be placed directly at the bottom. Of course, it may also choose to extend back edge areas on the top, bottom, left, and right sides of the frame body of the frame all in the width direction to accommodate more items. For the sake of aesthetics and sealing performance, curtain 6 is installed at a frame opening at the back of the frame. The installation method of the curtain and the frame is, for example, directly fixing four corners of the curtain on a frame opening wall with screws, or installing magnetic blocks at four corners of the curtain and pre-installing magnetic blocks with opposite magnetic properties on the corresponding frame opening wall to achieve magnetic fixing, or fixing four corners of the curtain to the frame opening with Velcro, etc. Of course, the curtain may be selected from flexible or hard materials according to needs.

As shown in FIG. 1, in the present embodiment, cable management rack 5 is installed in a position at the bottom of accommodating space 7 in the frame opening of the frame on one side of the support column to orderly manage cables through the cable management rack. A preferred structure of the cable management rack is as shown in FIG. 7. The cable management rack shown on the right part of FIG. 7 may be selected, body 50 thereof is a plate, a plurality of bumps 52 are fixed on a surface of the plate at intervals, and cable 12 is wound between different bumps. Alternatively, as shown in the middle part of FIG. 7, the body of the cable management rack is of a split structure. Each split body 51 preferably adopts a T-shaped structure, and a plurality of bumps 52 are formed at intervals on a longitudinal end thereof. The bumps are also preferably T-shaped, longitudinal ends of the T-shaped bumps are fixed to or integrally formed on the split body, and multiple split bodies form the cable management rack. As shown in FIG. 1, two split bodies 51 are fixed at an interval at the bottom of the frame opening to form cable management rack 5. The method of fixing the split body and the bottom of the frame opening is using, for example, integral injection molding, screw, glue, or the like to fix a lateral end of the split body to the bottom of the frame opening. Preferably, the lateral end of the split body is formed into an arc-shaped sheet, and two ends of the lateral end are formed into clamping blocks 53, as shown on the left part of FIG. 7. Correspondingly, a notch may be reserved at the bottom of the frame opening of the frame. During installation, the arc-shaped sheet is pressed at both ends to change the arc thereof and then placed in the notch. In addition, the cable rack may also be fixed on the left, right, or top wall of the frame opening according to requirements.

As shown in FIG. 1 and FIG. 9, in order to facilitate orderly arrangement of the cable, in the present embodiment, two L-shaped pendants 42 are formed at an interval on the back of the middle part of the hanging arm, the two pendants are used to fix annular elastic rope 8. The elastic rope is a wire body made of an elastic material. The cable can be tied directly with the elastic rope, or an item such as the cable can directly pass through a gap between the elastic rope and the hanging arm, and the item is clamped by the elastic rope.

For ease of use, a base, such as a commonly used disc-shaped base and a bar-shaped base, is installed at the bottom of the support column to improve balance. The base is a commonly used apparatus and can be selected according to requirements, which will not be shown in the drawing.

The frame body of the frame can be integrally formed, or a plurality of plates are connected to form a rectangular or polygonal frame body, and the material of the frame may be, for example, a polymer material or a metal material.

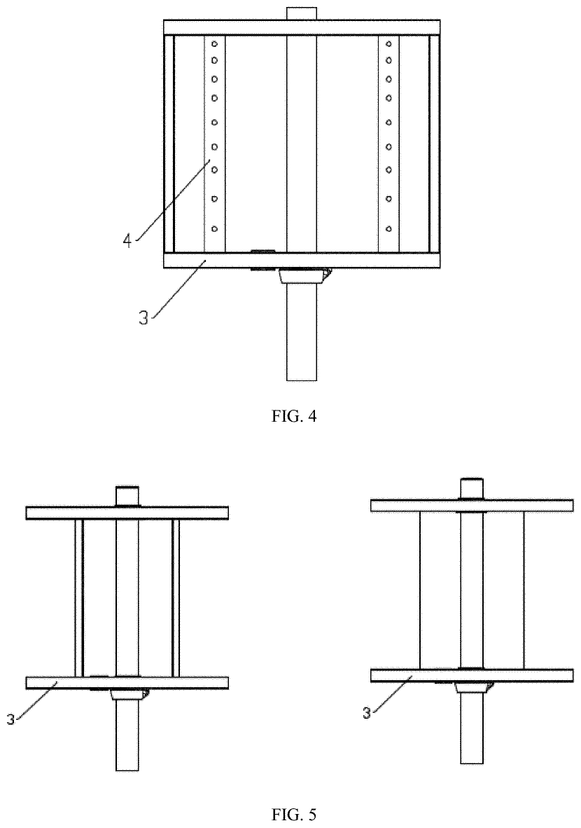

In addition, in some embodiments, the structure of the frame may be selected according to requirements. FIG. 5 shows a common tic-tac-toe-like frame body structure, on the left part of FIG. 5, two strip-shaped or rod-shaped frame bodies are fixed at an interval between the top and bottom frame bodies to form tic-tac-toe-like frame 3. Holes are opened at corresponding positions in the middle of the top and bottom to form jacks for the support column to protrude in, and an accommodating space is formed in an opening of the tic-tac-toe frame. Alternatively, as shown on the right part of FIG. 5, common I-shaped frame 3 is formed by connecting plate-like frame bodies between the top and bottom frame bodies, and a space enclosed by the top and bottom forms an accommodating space.

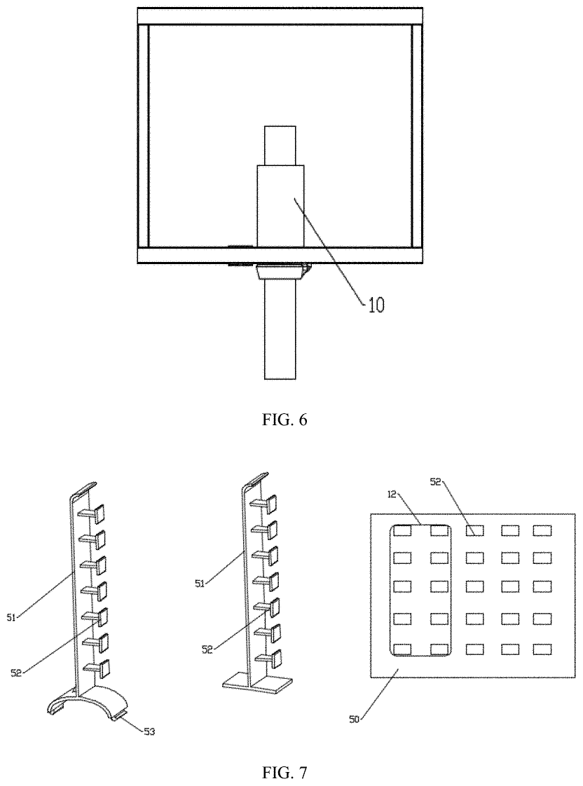

In addition, during implementation, the depth of the jack may be selected according to requirements. As shown in FIG. 6, a hole is opened at the frame bottom of the frame body, and a hole wall of jack 3 extends upward to a middle area of a frame opening in an axial direction of the support column, thus increasing a contact area with the support column. The end of the support column can directly protrude into the jack.

In addition, the structure shown in FIG. 10 can also enable the frame to form a rotational connection with the support column. Inserting column 16 is fixed in a middle position at the bottom of frame 3, and the end of corresponding support column 1 has a hole reserved in the axial direction. The inserting column is inserted into the hole, and the bottom of the frame abuts against the tray to form a support.

### Embodiment 2

Referring to FIG. 10 and FIG. 11, in the present embodiment, a support frame is fixedly connected to a frame. The support frame includes support column 1. Two support columns 1 are selected and fixed on two sides of frame 3 respectively in parallel by, for example, a glue, a bolt, or a structure shown in the drawing. Bottoms of two side plates of the frame extend downward to directly form support columns 1. Strip-shaped base 16 is installed at the bottom of the support column, which is convenient to use. As for the structure of frame 3, the structure of cable management rack 5, the structures of hanging arm 4, elastic rope 8, the curtain, and like all follow the description in Embodiment 1.

In addition, there may also be one support column, which is directly fixed at the bottom of the frame, such as in the middle position, or there may be multiple support columns fixed at the bottom of the frame at intervals.

The above descriptions are only the preferred embodiments of the present invention, and the protection scope of the present invention is not limited to the above embodiments. All technical solutions that fall within the idea of the present invention belong to the protection scope of the present invention. It should be pointed out that for those of ordinary skill in the art, several improvements and modifications made without departing from the principle of the present invention should also be regarded as the protection scope of the present invention.

1. A TV bracket, comprising a support frame and a frame for installing a TV, the frame being supported by the support frame, wherein the support frame is rotatably connected to the frame, the frame is of a frame body structure, an end frame opening of the frame is provided with a hanging arm for installing the TV, a space in a frame opening behind the hanging arm forms an accommodating space, and a cable management rack is arranged in the accommodating space.

2. The TV bracket of claim 1, wherein the support frame comprises a support column and a tray, the tray is arranged on the support column, a jack is arranged at the bottom of the frame and extends in an axial direction of the support column, an end of the support column protrudes into the jack, and the tray abuts against the bottom of the frame body of the frame to support it.

3. The TV bracket of claim 2, wherein the frame has holes opened at corresponding positions at middle of the bottom and at the top of the frame body to form jacks.

4. The TV bracket of claim 2, wherein the tray is arranged over the support column, and abuts against the support column by a first fastener arranged on a peripheral side of the tray to stay at a position of the support column.

5. The TV bracket of claim 2, wherein the jack on the frame and the support column are loosely fitted, a protruding component is arranged on a surface of the tray abutting against the bottom of the frame, and an arc-shaped groove is arranged correspondingly at a position of the bottom of the frame for the protruding component to protrude in.

6. The TV bracket of claim 5, wherein a second fastener is screwed to the bottom of the tray, and a top of the second fastener protrudes from the surface of the tray abutting against the bottom of the frame to form the protruding component.

7. The TV bracket of claim 5, wherein the protruding component is integrally formed on the surface of the tray abutting against the bottom of the frame body.

8. The TV bracket of claim 2, wherein the support frame comprises a support column and a tray, the tray is fixed at an end of the support column, a hole is arranged in an axial direction at the end of the support column, an inserting column is arranged at the bottom of the frame, the inserting column is inserted into the hole, and the tray abuts against the bottom of the frame to form a support.

9. The TV bracket of claim 1, wherein a curtain is arranged at a frame opening on the back of the frame to cover the frame opening.

10. The TV bracket of claim 1, wherein the cable manager comprises a body, and at least one surface of the body is provided with a plurality of bumps at intervals.

11. The TV bracket of claim 1, wherein two ends of the hanging arm are bent in the same direction, one end is bent into an L shape, and the other end is bent into a hook body, a top or bottom surface of the frame corresponding to the hook body is provided with a plurality of holes at intervals in a length direction for a hook end of the hook body to protrude in, and the end bent into the L shape is fixed to the bottom or top of the frame by a third fastener.

12. The TV bracket of claim 1, wherein an elastic rope is arranged on the hanging arm.

13. A TV bracket, comprising a support frame and a frame for installing a TV, the frame being supported by the support frame, wherein the support frame is fixedly connected to the frame, the frame is of a frame body structure, an end frame opening of the frame is provided with a hanging arm for installing the TV, a space in a frame opening behind the hanging arm forms an accommodating space, and a cable management rack is arranged in the accommodating space.

14. The TV bracket of claim 13, wherein the support frame comprises at least one support column, and the support column is fixedly connected to the frame.

15. The TV bracket of claim 14, wherein there are two support columns arranged oppositely on two sides of the bottom of the frame.

16. The TV bracket of claim 13, wherein a curtain is provided at a frame opening on the back of the frame to cover the frame opening.

17. The TV bracket of claim 13, wherein the cable manager comprises a body, and at least one surface of the body is provided with a plurality of bumps at intervals.

18. The TV bracket of claim 13, wherein two ends of the hanging arm are bent in the same direction, one end is bent into an L shape, and the other end is bent into a hook body, a top or bottom surface of the frame corresponding to the hook body is provided with a plurality of holes at intervals in a length direction for a hook end of the hook body to protrude in, and the end bent into the L shape is fixed to the bottom or top of the frame by a third fastener.

19. The TV bracket of claim 13, wherein an elastic rope is arranged on the hanging arm.
